(19) United States
(12) Patent Application Publication
(10) Pub. No.: US 2018/0178840 A1
(43) Pub. Date: Jun. 28, 2018

(54) AUTOMATIC VEHICLE PARKING ASSISTANCE CORRECTING SYSTEM WITH INSTANT ENVIRONMENTAL DETECTION AND CORRECTING METHOD THEREOF

(71) Applicant: Automotive Research & Testing Center, Changhua County (TW)

(72) Inventors: Ming-Hung LI, Changhua County (TW); Bo-Han LIN, Changhua County (TW); Ming-Hong HUNG, Changhua County (TW)

(21) Appl. No.: 15/393,224

(22) Filed: Dec. 28, 2016

(51) Int. Cl. B62D 15/02; G05D 1/02; G08G 1/16

(52) U.S. Cl. CPC B62D 15/0285; B60R 11/04; G08G 1/168; G05D 1/0214

(57) ABSTRACT

An automatic vehicle parking assistance correcting system with instant environmental detection for detecting at least one surrounding vehicle and immediately correcting a driving vehicle includes a vehicle sensor, a plurality of distance sensors and an electronic control unit. The vehicle sensor detects a vehicle parameter data of the driving vehicle and outputs the vehicle parameter data. The distance sensors detect the surrounding vehicle located around the driving vehicle and output a plurality of distance values between the driving vehicle and the surrounding vehicle. The electronic control unit receives the distance values and the vehicle parameter data to generate a parking space data, and calculates the distance values, the parking space data and the vehicle parameter data to generate an initial parking trajectory according to a trajectory planning algorithm.

### BACKGROUND

### Technical Field

The present disclosure relates to a vehicle parking assistance correcting system and a correcting method thereof. More particularly, the present disclosure relates to an automatic vehicle parking assistance correcting system with instant environmental detection and a correcting method thereof.

### Description of Related Art

With the progress of time and the development of science and technology, more and more automatic technologies have become an important part of our daily life and transformed our lives. Today, many people want a higher quality of life and more and more people want to have a vehicle which can apply an automatic vehicle parking assistance, so that the requirement encourages the technical staff to analyze how to accurately park the vehicle at the correct position. Therefore, in the past many automatic vehicle parking assistance systems have been developed in the actual application.

One conventional technique is an automatic vehicle parking assistance system for assisting a parking process of the driving vehicle into a longitudinal parking space. The longitudinal parking space is arranged next to a carriageway. The automatic vehicle parking assistance system has a measuring device and an evaluation device. The measuring device is used for measuring the parking space while the driving vehicle travels past and determining the position of a front boundary and/or of a rear boundary of the longitudinal parking space. The evaluation device is used for determining the position of the front boundary and/or of the rear boundary, a parked position of the driving vehicle in the longitudinal parking space and a parking travel. Hence, the parking position of the driving vehicle can be defined by the evaluation unit in a particularly reliable way. The profile of the travel of the vehicle is measured by the measuring device as the driving vehicle passes the longitudinal parking space. The profile of the travel of the driving vehicle is additionally taken into account in the definition of the parked position of the driving vehicle by the evaluation device. However, when the surrounding vehicle is moved or the environment is changed during the parking procedure, collisions or accidents may happen between the surrounding vehicle and the driving vehicle.

Another conventional technique is an automatic vehicle parking assistance system which includes at least one camera and an electronic control unit disposed on the driving vehicle. The camera is used for capturing obstacles or the boundary of the parking space. The electronic control unit is signally connected to the camera and controls the driving vehicle to park in the parking space. However, when the surrounding vehicle is moved or the environment is changed during the parking procedure, collisions or accidents may happen between the surrounding vehicle and the driving vehicle. Therefore, an automatic vehicle parking assistance correcting system and a correcting method thereof having the features of instant environmental detection and parking trajectory replanning correction during the parking process are commercially desirable.

### SUMMARY

According to one aspect of the present disclosure, an automatic vehicle parking assistance correcting system with instant environmental detection for detecting at least one surrounding vehicle and immediately correcting a driving vehicle includes a vehicle sensor, a plurality of distance sensors and an electronic control unit. The vehicle sensor is disposed on the driving vehicle. The vehicle sensor detects a vehicle parameter data of the driving vehicle and outputs the vehicle parameter data. The distance sensors are disposed around the driving vehicle. The distance sensors detect the surrounding vehicle located around the driving vehicle and output a plurality of distance values between the driving vehicle and the surrounding vehicle. The electronic control unit is disposed on the driving vehicle and is signally connected to the vehicle sensor and the distance sensors. The electronic control unit receives the distance values and the vehicle parameter data to generate a parking space data, and the electronic control unit calculates the distance values, the parking space data and the vehicle parameter data to generate an initial parking trajectory according to a trajectory planning algorithm. When at least one of the distance values is changed, the electronic control unit calculates the distance values, the parking space data and the vehicle parameter data to generate a replanning parking trajectory.

According to another aspect of the present disclosure, an automatic vehicle parking assistance correcting method with instant environmental detection for detecting at least one surrounding vehicle and immediately correcting a driving vehicle includes a parking space scanning step, a parking trajectory generating step and an instant environmental detecting step. The parking space scanning step is for detecting the surrounding vehicle located around the driving vehicle and outputting a plurality of distance values between the driving vehicle and the surrounding vehicle to an electronic control unit by a plurality of distance sensors. The parking trajectory generating step is for generating a vehicle parameter data of the driving vehicle and outputting the vehicle parameter data to the electronic control unit by a vehicle sensor. The electronic control unit receives the distance values and the vehicle parameter data to generate a parking space data. The electronic control unit calculates the distance values, the parking space data and the vehicle parameter data to generate an initial parking trajectory according to a trajectory planning algorithm. The instant environmental detecting step is for detecting whether or not at least one of the distance values is changed. When at least one of the distance values is changed, the electronic control unit calculates the distance values, the parking space data and the vehicle parameter data to generate a replanning parking trajectory.

### BRIEF DESCRIPTION OF THE DRAWINGS

The present disclosure can be more fully understood by reading the following detailed description of the embodiment, with reference made to the accompanying drawings as follows:

FIG. 1 is a block diagram showing an automatic vehicle parking assistance correcting system with instant environmental detection according to one embodiment of the present disclosure;

FIG. 2A is a block diagram showing the automatic vehicle parking assistance correcting system of FIG. 1 disposed on a driving vehicle;

FIG. 2B is a block diagram showing a plurality of motion parameters of the driving vehicle of FIG. 2A;

FIG. 3 is a block diagram showing an initial parking trajectory overlapping with a replanning parking trajectory of the driving vehicle of FIG. 2A when a front vehicle moves forward or a back vehicle moves backward;

FIG. 4 is a block diagram showing an initial parking trajectory and a replanning parking trajectory of the driving vehicle of FIG. 2A when the front vehicle moves backward;

FIG. 5 is a block diagram showing an initial parking trajectory and a replanning parking trajectory of the driving vehicle of FIG. 2A when the back vehicle moves forward;

FIG. 6 is a flow chart showing an automatic vehicle parking assistance correcting method with instant environmental detection according to one embodiment of the present disclosure; and

FIG. 7 is a flow chart showing an automatic vehicle parking assistance correcting method with instant environmental detection according to another embodiment of the present disclosure.

### DETAILED DESCRIPTION

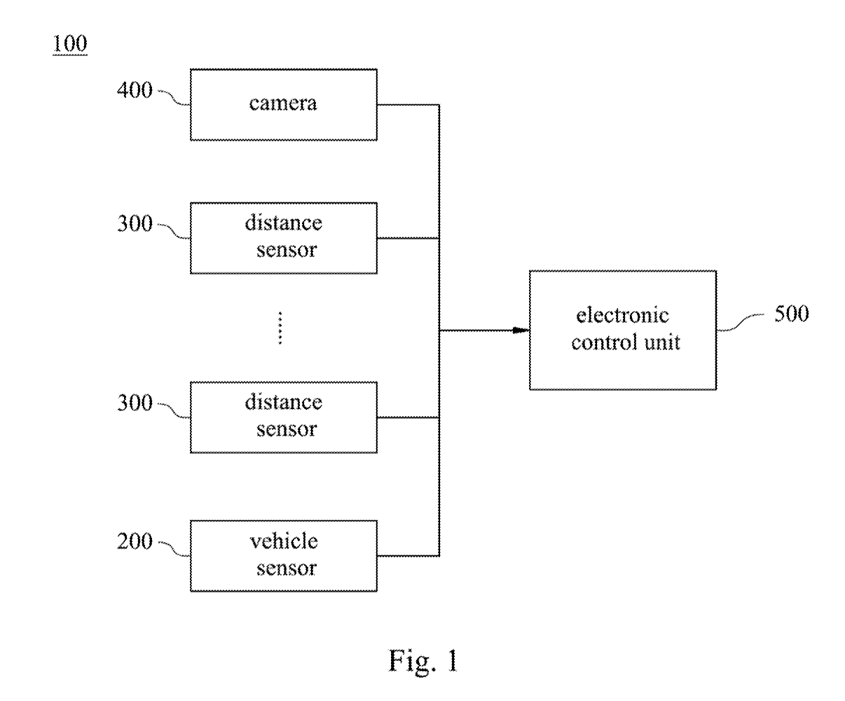

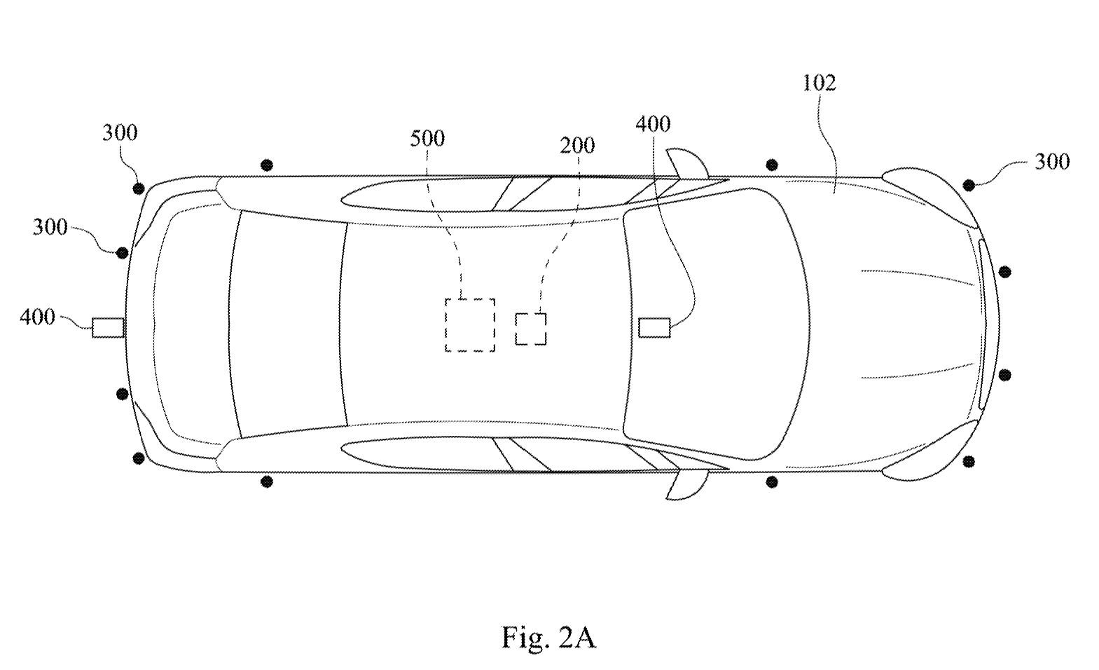

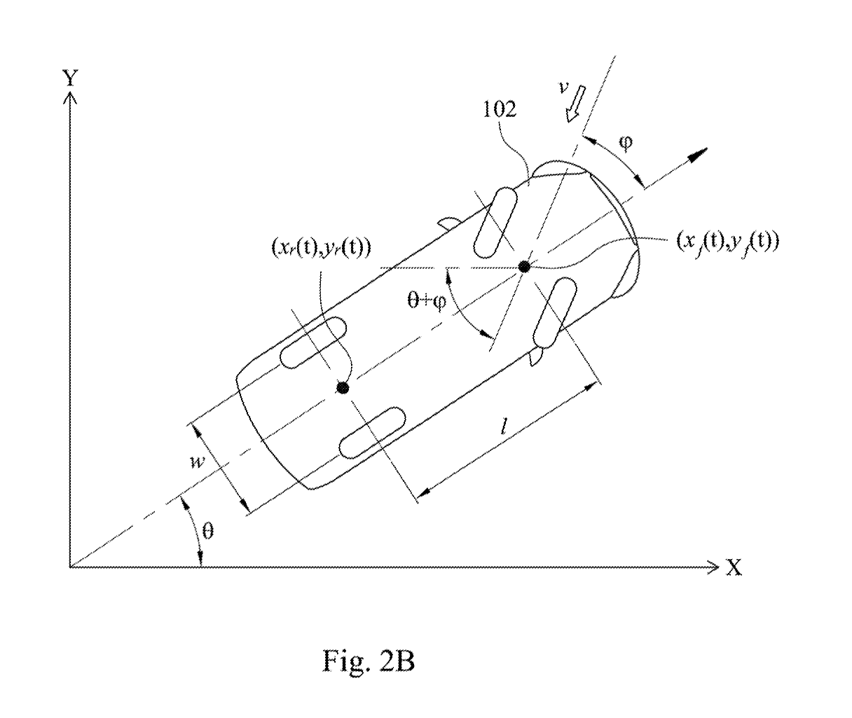

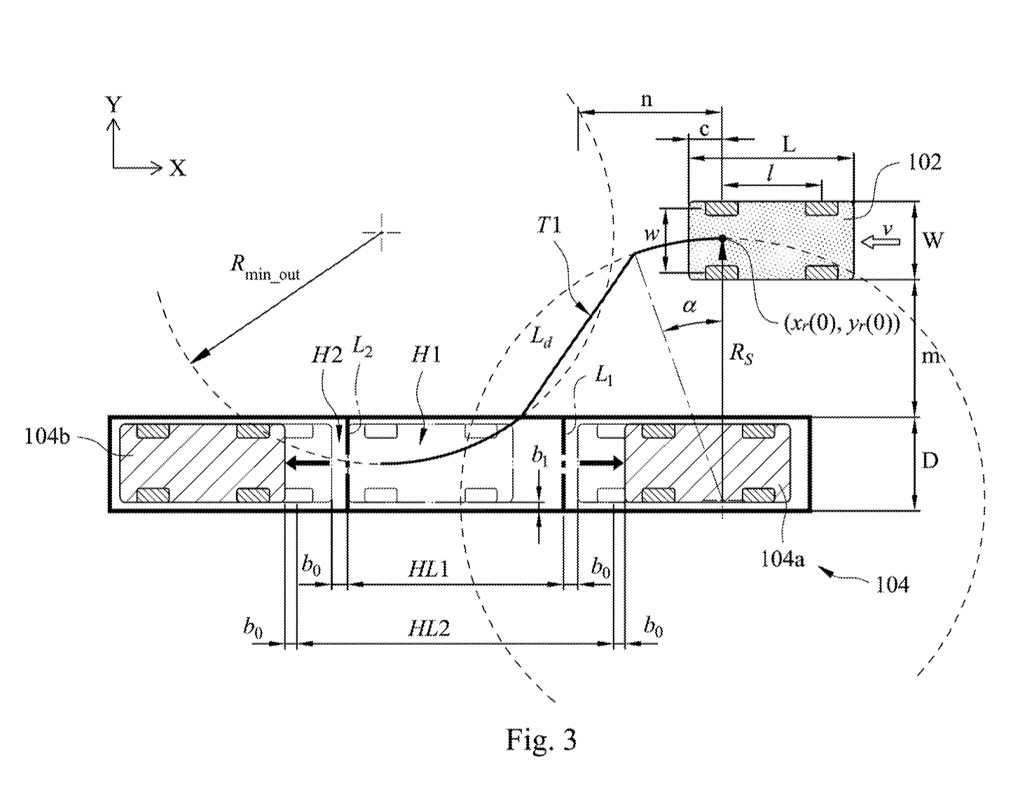

FIG. 1 is a block diagram showing an automatic vehicle parking assistance correcting system 100 with instant environmental detection according to one embodiment of the present disclosure; FIG. 2A is a block diagram showing the automatic vehicle parking assistance correcting system 100 of FIG. 1 disposed on a driving vehicle 102; FIG. 2B is a block diagram showing a plurality of motion parameters of the driving vehicle 102 of FIG. 2A; and FIG. 3 is a block diagram showing an initial parking trajectory T1 overlapping with a replanning parking trajectory T2 of the driving vehicle 102 of FIG. 2A when a front vehicle 104a moves forward or a back vehicle 104b moves backward. In FIGS. 1-3, the automatic vehicle parking assistance correcting system 100 with instant environmental detection is disposed on the driving vehicle 102 for detecting at least one surrounding vehicle 104 and immediately correcting the driving vehicle 102. The surrounding vehicle 104 may be the front vehicle 104a or the back vehicle 104b. The automatic vehicle parking assistance correcting system 100 with instant environmental detection can also simultaneously detect two surrounding vehicles 104 which are the front vehicle 104a and the back vehicle 104b, respectively. The automatic vehicle parking assistance correcting system 100 with instant environmental detection includes a vehicle sensor 200, twelve distance sensors 300, two cameras 400 and an electronic control unit 500.

The vehicle sensor 200 is disposed on the driving vehicle 102, and the vehicle sensor 200 detects a vehicle parameter data of the driving vehicle 102 and outputs the vehicle parameter data to the electronic control unit 500. The vehicle parameter data include a vehicle length L, a vehicle width W, a rear wheel distance w, a rear wheel central point (xᵣ(0), yᵣ(0)), (xᵣ(t), yᵣ(t)), a front wheel central point (x_{f}(t), y_{f}(t)), a vector v of the front wheel central point, a length c of a rear portion of the driving vehicle 102, a distance l between the front wheel central point and the rear wheel central point, a first angle θ between a central axis of the driving vehicle 102 and a X-axis, and a second angle φ which is a steering angle of the front wheel central point (x_{f}(t), y_{f}(t)). The central axis of the driving vehicle 102 is a virtual connecting line between the rear wheel central point (xᵣ(t), yᵣ(t)) and the front wheel central point (x_{f}(t), y_{f}(t)). The vehicle parameter data are used to calculate the initial parking trajectory T1 and the replanning parking trajectory T2 of the driving vehicle 102.

The distance sensors 300 are disposed around the driving vehicle 102. The distance sensors 300 detect the surrounding vehicles 104 including the front vehicle 104a and the back vehicle 104b located around the driving vehicle 102 and output a plurality of distance values m, n, D, b₀, b₁, HL1, HL2 to the electronic control unit 500. The distance sensors 300 may be an ultrasonic sensor, an infrared sensor, a laser sensor, a radar sensor, a light detection and ranging (LiDAR) sensor or other distance measuring sensors. In addition, the distance value m outputted from the distance sensors 300 represents a distance between the driving vehicle 102 and the front vehicle 104a in a Y-axis direction. The distance value n represents a distance between the rear wheel central point of the driving vehicle 102 and the rear end of the front vehicle 104a in the X-axis direction. The distance value D represents a width of a parking space H1. The distance value b₀ represents a distance between a first virtual line L₁ and the rear end of the front vehicle 104a, and the distance value b₀ also represents a distance between a second virtual line L₂ and a front end of the back vehicle 104b. The distance value b represents a gap between the driving vehicle 102 in the parking space H1 and an edge of the parking space H1. The distance value D is equal to the sum of two distance values b₁ and the vehicle width W. The distance values HL1, HL2 represent lengths of the parking space H1, H2 in the X-axis direction, respectively. Accordingly, the distance sensors 300 can immediately obtain the relative distances and corresponding position information between the driving vehicle 102 and the surrounding vehicles 104 so as to perform the calculation during a parking procedure.

The two cameras 400 are disposed on the front portion and the rear portion of the driving vehicle 102, respectively. One of the two cameras 400 disposed on the front portion is directed forward of the driving vehicle 102 (i.e. in a positive X-axis direction). The other one of the two cameras 400 disposed on the rear portion is directed backward of the driving vehicle 102 (i.e. in a negative X-axis direction). The two cameras 400 are used to observe the situation in front of and behind the driving vehicle 102, thereby being operated as an auxiliary image identification apparatus.

The electronic control unit (ECU) 500 is disposed on the driving vehicle 102 and is signally connected to the vehicle sensor 200, the distance sensors 300 and the two cameras 400. The electronic control unit 500 receives the distance values m, n, D, b₀, b₁, HL1, HL2 and the vehicle parameter data to generate a parking space data, and the electronic control unit 500 calculates the distance values m, n, D, b₀, b₁, HL1, HL2, the parking space data and the vehicle parameter data to generate the initial parking trajectory T1 according to a trajectory planning algorithm. In detail, the electronic control unit 500 stores a predetermined safety distance. The parking space data generated by the electronic control unit 500 are corresponding to the parking space H1, H2. The parking space data of the parking space H includes a first virtual line L₁ and a second virtual line L₂. There is a first distance between the first virtual line L₁ and the front vehicle 104a. There is a second distance between the second virtual line L₂ and the back vehicle 104b. The first distance and the second distance are both equal to the distance value b₀. The first distance and the second distance are greater than or equal to the predetermined safety distance. The first virtual line L₁ is located in front of the second virtual line L₂. The distance values HL1 is greater than the vehicle length L. The initial parking trajectory T1 and the trajectory planning algorithm can be described as follows:

$$\begin{matrix}{x}_{r} ( t ) = \int v \cdot cos θ cos ϕ dt = l \cdot cot ϕ \cdot sin ( \frac{v \cdot sin ϕ}{l} t ) , & ( 1 ) \\ {y}_{r} ( t ) = \int v \cdot sin θ cos ϕ dt = - l \cdot cot ϕ \cdot cos ( \frac{v \cdot sin ϕ}{l} t ) + l cot ϕ . & ( 2 )\end{matrix}$$

Wherein xᵣ(t) and yᵣ(t) represent the X-axis position and the Y-axis position of the rear wheel central point, respectively. t represents time. Moreover, the initial parking trajectory T1 includes a first rear wheel central radius R_{S}, a first parking angle α, an initial straight path L_{d} and a second rear wheel central radius Rₘᵢₙ_{_}ₒᵤₜ. Therefore, the driving vehicle 102 can be accurately parked into the parking space H1 according to the initial parking trajectory T1 calculated by the electronic control unit 500 without colliding with the front vehicle 104a and the back vehicle 104b.

In order to solve the problem of the conventional parking technology which performs only an environmental detection before parking, the automatic vehicle parking assistance correcting system 100 with instant environmental detection of the present disclosure is proposed. The automatic vehicle parking assistance correcting system 100 is an auxiliary parking technique for detecting variations of the environment at any time. When at least one surrounding vehicle 104 is moved or the environment is changed during the parking procedure, the initial parking trajectory T1 may be blocked by one or more surrounding vehicles 104 (the front vehicle 104a, the back vehicle 104b or both) or other moving objects, and the automatic vehicle parking assistance correcting system 100 can automatically replan to generate a suitable parking trajectory. In other words, when at least one of the distance values m, n, D, b₀, b₁, HL1, HL2 is changed, the electronic control unit 500 calculates the distance values m, n, D, b₀, b₁, HL1, HL2, the parking space data of the parking space H1, H2 and the vehicle parameter data to generate the replanning parking trajectory T2. Therefore, the automatic vehicle parking assistance correcting system 100 with instant environmental detection of the present disclosure can provide an automatic replanning correction and the suitable replanning parking trajectory T2 so as to avoid collisions between surrounding vehicles 104 and the driving vehicle 102 and improve reliability and safety during a parking process. The following describes four different types of environmental changes with their corresponding automatic replanning correction of the automatic vehicle parking assistance correcting system 100. The four different types of environmental changes are “the front vehicle 104a moves forward”, “the back vehicle 104b moves backward”, “the front vehicle 104a moves backward” and “the back vehicle 104b moves forward”, respectively.

FIG. 3 is a block diagram showing an initial parking trajectory overlapping with a replanning parking trajectory of the driving vehicle of FIG. 2A when a front vehicle moves forward or a back vehicle moves backward. In FIG. 3, the two types of environmental changes which are “the front vehicle 104a moves forward” and “the back vehicle 104b moves backward” does not essentially affect the original parking space H1 because the first virtual line L₁ and the second virtual line L₂ are not blocked or covered by the surrounding vehicles 104. When the surrounding vehicle 104 (i.e. the front vehicle 104a) is located in front of the first virtual line L₁ and is moved in the positive X-axis direction, the first distance is increased, and at least one of the distance values b₀, HL2 of the distance sensors 300 is increased, so that the electronic control unit 500 calculates the distance values m, n, D, b₀, b₁, HL1, HL2, the parking space data of the parking space H1, H2 and the vehicle parameter data to generate the replanning parking trajectory T2. The replanning parking trajectory T2 substantially completely overlaps with the initial parking trajectory T1. On the other hand, when the surrounding vehicle 104 (i.e. the back vehicle 104b) is located behind the second virtual line L₂ and is moved in the negative X-axis direction, the second distance is increased, and at least one of the distance values b₀, HL2 of the distance sensors 300 is increased, so that the electronic control unit 500 calculates the distance values m, n, D, b₀, b₁, HL1, HL2, the parking space data of the parking space H1, H2 and the vehicle parameter data to generate the replanning parking trajectory T2. The replanning parking trajectory T2 substantially completely overlaps with the initial parking trajectory T1. In other words, the driving vehicle 102 is still traveled along the initial parking trajectory T1 generated by the electronic control unit 500 and is stopped at the parking space H1 between the first virtual line L₁ and the second virtual line L₂ during the parking procedure. It should be noted that no matter where the initial position of the front vehicle 104a or the back vehicle 104b is or no matter what the moving path of the front vehicle 104a or the back vehicle 104b is, the driving vehicle 102 is traveled along the initial parking trajectory T when the first virtual line L₁ and the second virtual line L₂ are not blocked or covered by the surrounding vehicles 104 or other moving objects.

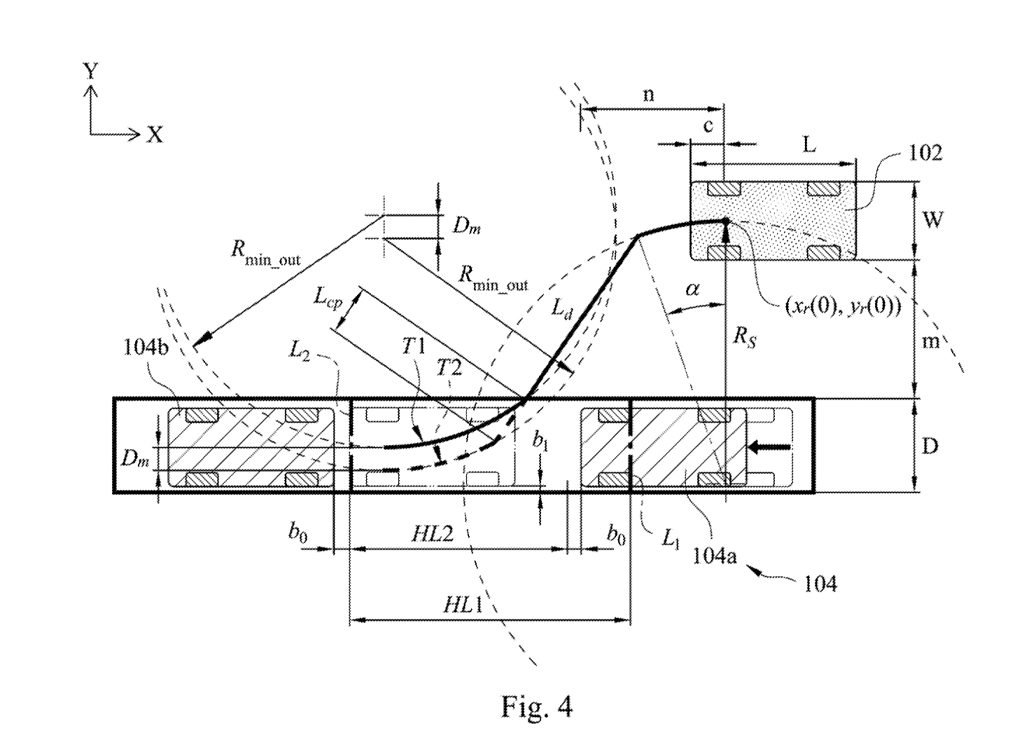

FIG. 4 is a block diagram showing an initial parking trajectory T1 and a replanning parking trajectory T2 of the driving vehicle of FIG. 2A when the front vehicle 104a moves backward. In FIG. 4, the type of environmental change which is “the front vehicle 104a moves backward” essentially affects the original parking space H1 because the first virtual line L₁ is blocked or covered by one of the surrounding vehicles 104 (i.e. the front vehicle 104a). In this situation, the rear portion of the front vehicle 104a is likely to collide with the right side of the driving vehicle 102. Due to the first virtual line L₁ blocked or covered by the front vehicle 104a, the distance values n, b₀, HL2 are changed, and the electronic control unit 500 calculates the distance values m, n, D, b₀, b₁, HL1, HL2, the parking space data of the parking space H2 and the vehicle parameter data to generate the replanning parking trajectory T2. In detail, when the surrounding vehicle 104 (i.e. the front vehicle 104a) is located in front of the first virtual line L₁ and is moved in the negative X-axis direction, the first distance is decreased, and at least one of the distance values b₀, HL2 of the distance sensors 300 is decreased. Furthermore, the distance value n is increased, so that the electronic control unit 500 calculates the distance values m, n, D, b₀, b₁, HL1, HL2, the parking space data of the parking space H1, H2 and the vehicle parameter data to generate the replanning parking trajectory T2. The replanning parking trajectory T2 includes a straight-line compensated distance L_{cp} and a parking depth moving distance Dₘ. The straight-line compensated distance L_{cp} represents a length of one straight line of the replanning parking trajectory T2. The straight line is communicated with the initial straight path L_{d}. The parking depth moving distance Dₘ is equal to the offset of the second rear wheel central radius Rₘᵢₙ_{_}ₒᵤₜ in the negative Y-axis direction, so that the replanning parking trajectory T2 partially overlaps with the initial parking trajectory T1. It is obvious that the difference between the replanning parking trajectory T2 and the initial parking trajectory T is that the replanning parking trajectory T2 has the straight line extending from the initial parking trajectory T1. Hence, the straight line of the replanning parking trajectory T2 allows the driving vehicle 102 to return to the normal direction at a later time, thus avoiding collisions between the driving vehicle 102 and the front vehicle 104a and improving reliability and safety during the parking process.

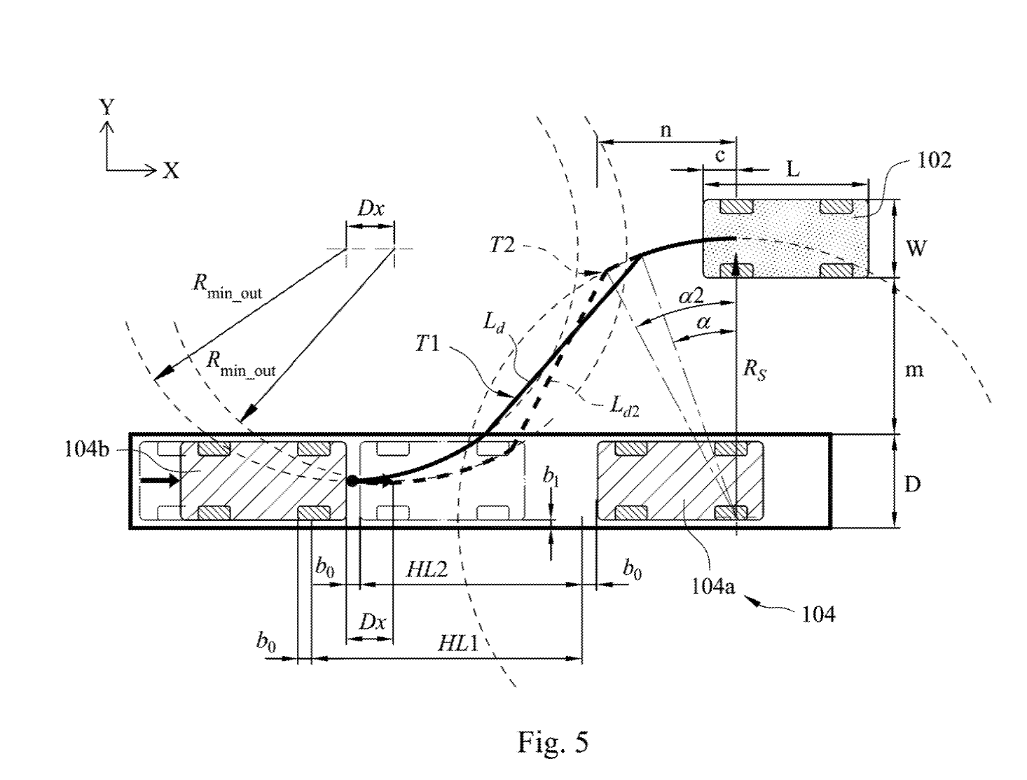

FIG. 5 is a block diagram showing an initial parking trajectory T1 and a replanning parking trajectory T2 of the driving vehicle of FIG. 2A when the back vehicle 104b moves forward. In FIG. 5, the type of environmental change which is “the back vehicle 104b moves forward” essentially affects the original parking space H1 because the second virtual line L₂ is blocked or covered by one of the surrounding vehicles 104 (i.e. the back vehicle 104b). In this situation, the front end of the front vehicle 104a is likely to collide with the rear end of the driving vehicle 102. Due to the second virtual line L₂ blocked or covered by the back vehicle 104b, the distance value b₀, HL2 is changed, and the electronic control unit 500 calculates the distance values m, n, D, b₀, b₁, HL1, HL2, the parking space data of the parking space H2 and the vehicle parameter data to generate the replanning parking trajectory T2. In detail, when the surrounding vehicle 104 (i.e. the back vehicle 104b) is located behind the second virtual line L₂ and is moved in the positive X-axis direction, the second distance is decreased, and at least one of the distance values b₀, HL2 of the distance sensors 300 is decreased, so that the electronic control unit 500 calculates the distance values m, n, D, b₀, b₁, HL1, HL2, the parking space data of the parking space H1, H2 and the vehicle parameter data to generate the replanning parking trajectory T2. The initial parking trajectory T1 includes the first rear wheel central radius R_{S}, the first parking angle α, the initial straight path L_{d} and the second rear wheel central radius Rₘᵢₙ_{_}ₒᵤₜ. The replanning parking trajectory T2 includes a second parking angle α2, a replanning straight path L_{d2} and a rear moving distance Dₓ. The initial straight path L_{d} is interleaved with the replanning straight path L_{d2} The second parking angle α2 is greater than the first parking angle α. An angle between the replanning straight path L_{d2} and the X-axis direction is greater than an angle between the initial straight path L_{d} and the X-axis direction, so that the replanning parking trajectory T2 partially overlaps with the initial parking trajectory T1. The back vehicle 104b moves forward the rear moving distance Dₓ which is equal to the offset of the second rear wheel central radius Rₘᵢₙ_{_}ₒᵤₜ in the positive X-axis direction. Accordingly, the change of the second parking angle α2 allows the driving vehicle 102 to stop in a forward position, and a final parking position of the rear end of the driving vehicle 102 can be moved forward a specific distance (i.e. the rear moving distance Dₓ) so as to avoid collisions between the rear end of the driving vehicle 102 and the front end of the back vehicle 104b and improve reliability and safety during the parking process.

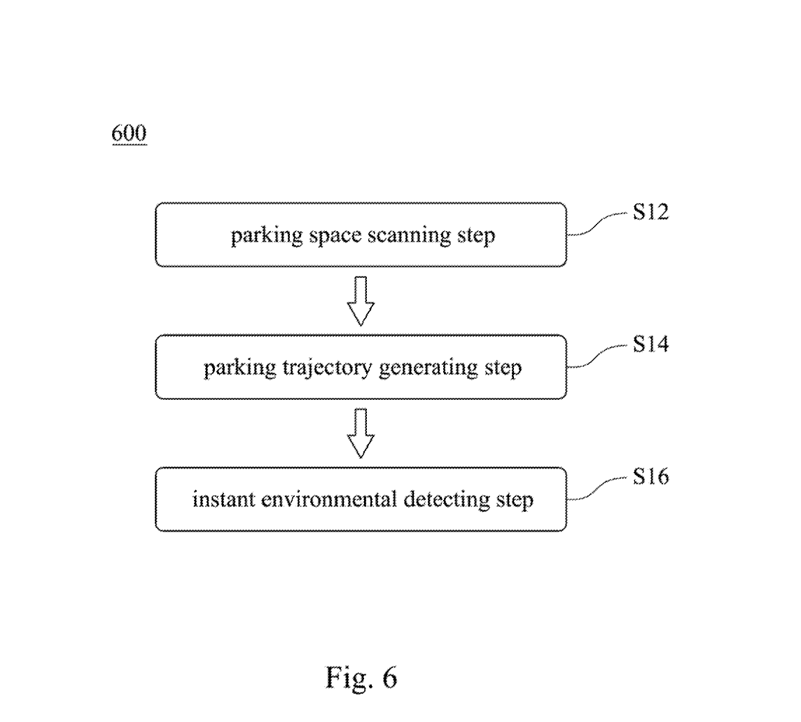

FIG. 6 is a flow chart showing an automatic vehicle parking assistance correcting method 600 with instant environmental detection according to one embodiment of the present disclosure. In FIGS. 2A and 6, the automatic vehicle parking assistance correcting method 600 with instant environmental detection for detecting at least one surrounding vehicle 104 and immediately correcting a driving vehicle 102 includes a parking space scanning step S12, a parking trajectory generating step S14 and an instant environmental detecting step S16.

The parking space scanning step S12 is for detecting the surrounding vehicle 104 located around the driving vehicle 102 and outputting a plurality of distance values m, n, D, b₀, b₁, HL1, HL2 between the driving vehicle 102 and the surrounding vehicle 104 to an electronic control unit 500 by a plurality of distance sensors 300. Moreover, the electronic control unit 500 receives the distance values m, n, D, b₀, b₁, HL1, HL2 to generate a parking space data of the parking space H1.

The parking trajectory generating step S14 is for generating a vehicle parameter data of the driving vehicle 102 and outputting the vehicle parameter data to the electronic control unit 500 by a vehicle sensor 200. The electronic control unit 500 calculates the distance values m, n, D, b₀, b₁, HL1, HL2, the parking space data of the parking space H1 and the vehicle parameter data to generate an initial parking trajectory T1 according to a trajectory planning algorithm. The trajectory planning algorithm satisfies the above-mentioned equations (1) and (2).

The instant environmental detecting step S16 is for detecting and verifying whether or not at least one of the distance values m, n, D, b₀, b₁, HL1, HL2 is changed. When at least one of the distance values m, n, D, b₀, b₁, HL1, HL2 is changed, the electronic control unit 500 calculates the distance values m, n, D, b₀, b₁, HL1, HL2, the parking space data of the parking space H2 and the vehicle parameter data to generate the replanning parking trajectory T2. In other words, when a parking environment is changed from the parking space H1 to the parking space H2 by the surrounding vehicle 104, the distance value is changed from HL1 to HL2, and the electronic control unit 500 generates the replanning parking trajectory T2 for immediate correction. Therefore, the automatic vehicle parking assistance correcting method 600 with instant environmental detection can detect variations of the environment in real-time during the parking procedure. If at least one surrounding vehicle 104 is moved or the environment is changed during the parking procedure, the initial parking trajectory T1 may be blocked or covered by one or more surrounding vehicles 104 or other moving objects, and the automatic vehicle parking assistance correcting method 600 with instant environmental detection can automatically replan to generate a suitable parking trajectory for immediate correction, thereby improving reliability and safety during the parking procedure.

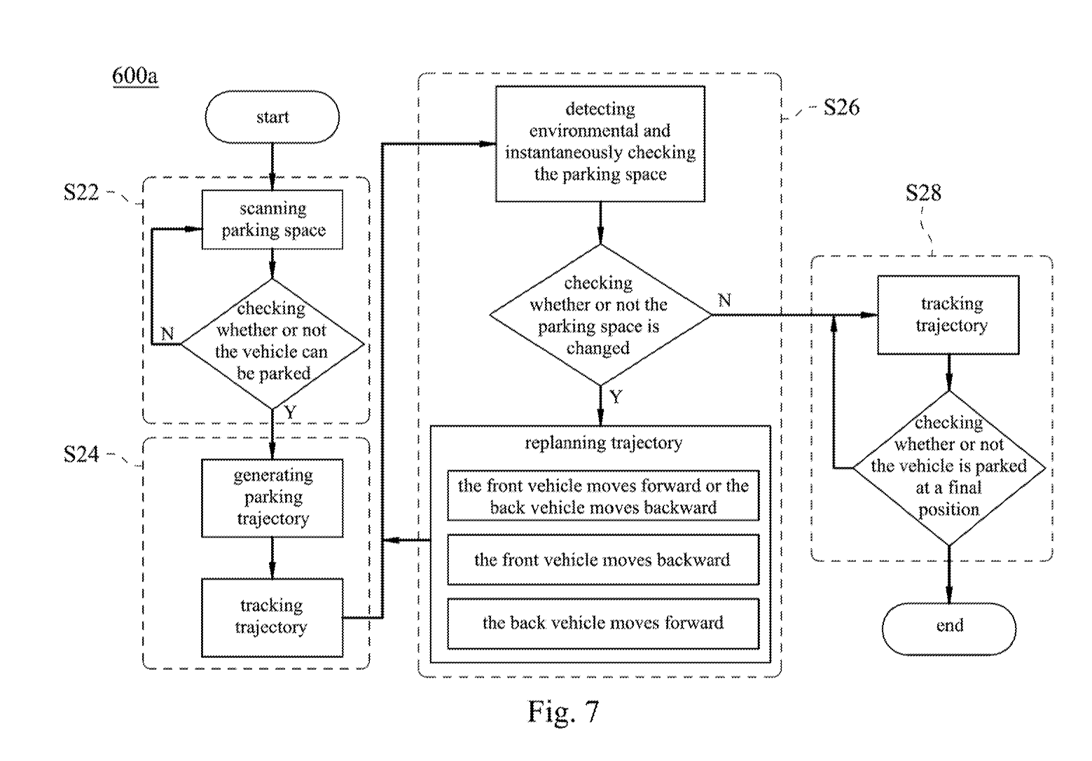

FIG. 7 is a flow chart showing an automatic vehicle parking assistance correcting method 600a with instant environmental detection according to another embodiment of the present disclosure. In FIGS. 2A and 7, the automatic vehicle parking assistance correcting method 600a with instant environmental detection includes a parking space scanning step S22, a parking trajectory generating step S24, an instant environmental detecting step S26 and a final position verifying step S28.

The parking space scanning step S22 is for detecting the surrounding vehicle 104 located around the driving vehicle 102 and outputting a plurality of distance values m, n, D, b₀, b₁, HL1, HL2 between the driving vehicle 102 and the surrounding vehicle 104 to an electronic control unit 500 by a plurality of distance sensors 300. The electronic control unit 500 stores a predetermined safety distance, and the electronic control unit 500 receives the distance values m, n, D, b₀, b₁, HL1, HL2 from the distance sensors 300 to generate a parking space data of the parking space H1. The parking space data includes a first virtual line L₁ and a second virtual line L₂. There is a first distance between the first virtual line L₁ and the front vehicle 104a, and there is a second distance between the second virtual line L₂ and the back vehicle 104b. The first distance and the second distance are both greater than or equal to the predetermined safety distance, and the first distance and the second distance are both equal to the distance value b₀. The first virtual line L₁ is located in front of the second virtual line L₂. In addition, the electronic control unit 500 checks whether or not the driving vehicle 102 can be parked in the parking space scanning step S22. For example, the electronic control unit 500 performs a comparison between the distance value HL1 and the vehicle length L and a comparison between the distance value b₀ and the predetermined safety distance. If the distance value HL1 is greater than or equal to the sum of two distance values b₀ and the vehicle length L, or the distance value b₀ is greater than or equal to the predetermined safety distance, the parking space scanning step 622 outputs “Y” which represents the driving vehicle 102 can be parked and then the parking trajectory generating step S24 is performed. In this situation, the first distance between the first virtual line L₁ and the front vehicle 104a and the second distance between the second virtual line L₂ and the back vehicle 104b are both greater than or equal to the predetermined safety distance. On the contrary, if the distance value HL1 is smaller than the sum of two distance values b and the vehicle length L, or the distance value b is smaller than the predetermined safety distance, the parking space scanning step S22 outputs “N” which represents the driving vehicle 102 cannot be parked and then detects the parking space H continuously. In this situation, the parking space H1 is too narrow to park the driving vehicle 102 into the parking space H1. If the driving vehicle 102 is forcibly parked into the parking space H1, a collision will occur.

The parking trajectory generating step S24 is for generating a vehicle parameter data of the driving vehicle 102 and outputting the vehicle parameter data to the electronic control unit 500 by a vehicle sensor 200. The electronic control unit 500 calculates the distance values m, n, D, b₀, b₁, HL1, HL2, the parking space data of the parking space H1 and the vehicle parameter data to generate an initial parking trajectory T1 according to a trajectory planning algorithm. The trajectory planning algorithm satisfies the above-mentioned equations (1) and (2). In addition, the electronic control unit 500 conducts a trajectory tracking operation according to the initial parking trajectory T1 and controls the driving vehicle 102 to move along the initial parking trajectory T1.

The instant environmental detecting step S26 is for detecting and verifying whether or not at least one of the distance values m, n, D, b₀, b₁, HL1, HL2 is changed. When at least one of the distance values m, n, D, b₀, b₁, HL1, HL2 is changed, the electronic control unit 500 calculates the distance values m, n, D, b₀, b₁, HL1, HL2, the parking space data of the parking space H2 and the vehicle parameter data to generate a replanning parking trajectory T2. In detail, the electronic control unit 500 automatically detects variations of the environment at any time. The electronic control unit 500 verifies whether or not the first virtual line L₁ and the second virtual line L₂ of the parking space H1 are blocked or covered by the surrounding vehicles 104 or other moving objects. When the parking environment is changed from the parking space H1 to the parking space H2, the electronic control unit 500 generates the replanning parking trajectory T2 for immediate correction. There are three categories of the four different types of environmental changes. The three categories are “the front vehicle 104a moves forward or the back vehicle 104b moves backward”, “the front vehicle 104a moves backward” and “the back vehicle 104b moves forward”, respectively. First, when the surrounding vehicle 104 is located in front of the first virtual line L₁ and is moved in the positive X-axis direction (i.e. the front vehicle 104a moves forward), or when the surrounding vehicle 104 is located behind the second virtual line L₂ and is moved in the negative X-axis direction (i.e. the back vehicle 104b moves backward), the first virtual line L₁ and the second virtual line L₂ are not blocked or covered by the surrounding vehicles 104 or other moving objects, so that the replanning parking trajectory T2 substantially completely overlaps with the initial parking trajectory T1. Second, when the surrounding vehicle 104 is located in front of the first virtual line L₁ and is moved in the negative X-axis direction (i.e. the front vehicle 104a moves backward), the first virtual line L₁ is blocked or covered by the front vehicle 104a, and the replanning parking trajectory T2 generated by the electronic control unit 500 includes the straight-line compensated distance L_{cp} and the parking depth moving distance Dₘ. The straight-line compensated distance L_{cp} represents the length of one straight line of the replanning parking trajectory T2. The straight line is communicated with the initial straight path L_{d}. The parking depth moving distance Dₘ is equal to the offset of the second rear wheel central radius Rₘᵢₙ_{_}ₒᵤₜ in the negative Y-axis direction, so that the replanning parking trajectory T2 partially overlaps with the initial parking trajectory T1. Third, when the surrounding vehicle 104 is located behind the second virtual line L₂ and is moved in the positive X-axis direction (i.e. the back vehicle 104b moves forward), the second virtual line L₂ is blocked or covered by the back vehicle 104b, and the replanning parking trajectory T2 generated by the electronic control unit 500 includes the replanning straight path L_{d2}. The initial straight path L_{d} of the initial parking trajectory T1 is interleaved with the replanning straight path L_{d2}. The angle between the replanning straight path L_{d2} and the X-axis direction is greater than the angle between the initial straight path L_{d} and the X-axis direction, so that the replanning parking trajectory T2 partially overlaps with the initial parking trajectory T1.

In the instant environmental detecting step S26, the electronic control unit 500 checking and verifying whether or not the parking space H1 is changed. If the parking space H1 is changed, the instant environmental detecting step S26 performs a generating processing of the replanning parking trajectory T2 via the electronic control unit 500. If the parking space H1 is not changed, the final position verifying step S28 is performed. The final position verifying step S28 is for controlling the electronic control unit 500 to conduct a trajectory tracking operation according to the latest parking trajectory, and controlling the driving vehicle 102 to move along the latest parking trajectory. Moreover, the final position verifying step S28 is for checking and verifying whether or not the driving vehicle 102 is parked at a final position until the parking process is finished. The final position is corresponding to an end point of the latest parking trajectory. Consequently, the automatic vehicle parking assistance correcting method 600a with instant environmental detection can replan and generate the replanning parking trajectory T2 according to the difference between the parking space H1 and the parking space H2 for immediate correction, thus controlling the driving vehicle 102 to correctly and safely park at the designated location and improving reliability and safety during the parking procedure.

According to the aforementioned embodiments and examples, the advantages of the present disclosure are described as follows.

1. The automatic vehicle parking assistance correcting system with instant environmental detection and the correcting method thereof of the present disclosure may provide the automatic replanning correction and the suitable replanning parking trajectory so as to avoid collisions when the surrounding vehicle is moved or the environment is changed.

2. The automatic vehicle parking assistance correcting system with instant environmental detection and the correcting method thereof of the present disclosure can control the driving vehicle to return to the normal direction at a later time, thus avoiding collisions between the driving vehicle and the front vehicle and improving reliability and safety during the parking process.

3. The automatic vehicle parking assistance correcting system with instant environmental detection and the correcting method thereof of the present disclosure can control the driving vehicle to stop in a forward position so as to avoid collisions between the rear end of the driving vehicle and the front end of the back vehicle and improve reliability and safety during the parking process.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An automatic vehicle parking assistance correcting system with instant environmental detection for detecting at least one surrounding vehicle and immediately correcting a driving vehicle, the automatic vehicle parking assistance correcting system with instant environmental detection comprising:
a vehicle sensor disposed on the driving vehicle for detecting a vehicle parameter data of the driving vehicle and outputting the vehicle parameter data;
a plurality of distance sensors disposed around the driving vehicle for detecting the surrounding vehicle located around the driving vehicle and output a plurality of distance values between the driving vehicle and the surrounding vehicle; and
an electronic control unit disposed on the driving vehicle and signally connected to the vehicle sensor and the distance sensors, wherein the electronic control unit receives the distance values and the vehicle parameter data to generate a parking space data, and the electronic control unit calculates the distance values, the parking space data and the vehicle parameter data to generate an initial parking trajectory according to a trajectory planning algorithm;
wherein when at least one of the distance values is changed, the electronic control unit calculates the distance values, the parking space data and the vehicle parameter data to generate a replanning parking trajectory.

2. The automatic vehicle parking assistance correcting system of claim 1, wherein,
the electronic control unit stores a predetermined safety distance, the parking space data comprises a first virtual line and a second virtual line, there is a first distance between the first virtual line and the surrounding vehicle, there is a second distance between the second virtual line and the surrounding vehicle, the first distance and the second distance are both greater than or equal to the predetermined safety distance, and the first virtual line is located in front of the second virtual line.

3. The automatic vehicle parking assistance correcting system of claim 2, wherein,
when the surrounding vehicle is located in front of the first virtual line and is moved in a positive X-axis direction, the first distance is increased, and at least one of the distance values of the distance sensors is increased, so that the electronic control unit calculates the distance values, the parking space data and the vehicle parameter data to generate the replanning parking trajectory, and the replanning parking trajectory substantially completely overlaps with the initial parking trajectory.

4. The automatic vehicle parking assistance correcting system of claim 2, wherein,
when the surrounding vehicle is located behind the second virtual line and is moved in a negative X-axis direction, the second distance is increased, and at least one of the distance values of the distance sensors is increased, so that the electronic control unit calculates the distance values, the parking space data and the vehicle parameter data to generate the replanning parking trajectory, and the replanning parking trajectory substantially completely overlaps with the initial parking trajectory.

5. The automatic vehicle parking assistance correcting system of claim 2, wherein,
when the surrounding vehicle is located in front of the first virtual line and is moved in a negative X-axis direction, the first distance is decreased, and at least one of the distance values of the distance sensors is decreased, so that the electronic control unit calculates the distance values, the parking space data and the vehicle parameter data to generate the replanning parking trajectory, the replanning parking trajectory comprises a straight-line compensated distance and a parking depth moving distance, and the replanning parking trajectory partially overlaps with the initial parking trajectory.

6. The automatic vehicle parking assistance correcting system of claim 2, wherein,
when the surrounding vehicle is located behind the second virtual line and is moved in a positive X-axis direction, the second distance is decreased, and at least one of the distance values of the distance sensors is decreased, so that the electronic control unit calculates the distance values, the parking space data and the vehicle parameter data to generate the replanning parking trajectory, the initial parking trajectory comprises an initial straight path, the replanning parking trajectory comprises a replanning straight path, the initial straight path is interleaved with the replanning straight path, and the replanning parking trajectory partially overlaps with the initial parking trajectory.

7. An automatic vehicle parking assistance correcting method with instant environmental detection for detecting at least one surrounding vehicle and immediately correcting a driving vehicle, the automatic vehicle parking assistance correcting method comprising:
providing a parking space scanning step, wherein the parking space scanning step is for detecting the surrounding vehicle located around the driving vehicle and outputting a plurality of distance values between the driving vehicle and the surrounding vehicle to an electronic control unit by a plurality of distance sensors;
providing a parking trajectory generating step, wherein the parking trajectory generating step is for generating a vehicle parameter data of the driving vehicle and outputting the vehicle parameter data to the electronic control unit by a vehicle sensor, the electronic control unit receives the distance values and the vehicle parameter data to generate a parking space data, and the electronic control unit calculates the distance values, the parking space data and the vehicle parameter data to generate an initial parking trajectory according to a trajectory planning algorithm; and
providing an instant environmental detecting step, wherein the instant environmental detecting step is for detecting whether or not at least one of the distance values is changed, when at least one of the distance values is changed, the electronic control unit calculates the distance values, the parking space data and the vehicle parameter data to generate a replanning parking trajectory.

8. The automatic vehicle parking assistance correcting method of claim 6, wherein,
in the parking space scanning step, the electronic control unit stores a predetermined safety distance, the parking space data comprises a first virtual line and a second virtual line, there is a first distance between the first virtual line and the surrounding vehicle, there is a second distance between the second virtual line and the surrounding vehicle, the first distance and the second distance are both greater than or equal to the predetermined safety distance, and the first virtual line is located in front of the second virtual line.

9. The automatic vehicle parking assistance correcting method of claim 7, wherein,
in the instant environmental detecting step, when the surrounding vehicle is located in front of the first virtual line and is moved in a positive X-axis direction, the first distance is increased, and at least one of the distance values of the distance sensors is increased, so that the electronic control unit calculates the distance values, the parking space data and the vehicle parameter data to generate the replanning parking trajectory, and the replanning parking trajectory substantially completely overlaps with the initial parking trajectory;

10. The automatic vehicle parking assistance correcting method of claim 7, wherein,
in the instant environmental detecting step, when the surrounding vehicle is located behind the second virtual line and is moved in a negative X-axis direction, the second distance is increased, and at least one of the distance values of the distance sensors is increased, so that the electronic control unit calculates the distance values, the parking space data and the vehicle parameter data to generate the replanning parking trajectory, and the replanning parking trajectory substantially completely overlaps with the initial parking trajectory.

11. The automatic vehicle parking assistance correcting method of claim 7, wherein,
in the instant environmental detecting step, when the surrounding vehicle is located in front of the first virtual line and is moved in a negative X-axis direction, the first distance is decreased, and at least one of the distance values of the distance sensors is decreased, so that the electronic control unit calculates the distance values, the parking space data and the vehicle parameter data to generate the replanning parking trajectory, the replanning parking trajectory comprises a straight-line compensated distance and a parking depth moving distance, and the replanning parking trajectory partially overlaps with the initial parking trajectory.

12. The automatic vehicle parking assistance correcting method of claim 7, wherein,
in the instant environmental detecting step, when the surrounding vehicle is located behind the second virtual line and is moved in a positive X-axis direction, the second distance is decreased, and at least one of the distance values of the distance sensors is decreased, so that the electronic control unit calculates the distance values, the parking space data and the vehicle parameter data to generate the replanning parking trajectory, the initial parking trajectory comprises an initial straight path, the replanning parking trajectory comprises a replanning straight path, the initial straight path is interleaved with the replanning straight path, and the replanning parking trajectory partially overlaps with the initial parking trajectory.
